(19) United States
(12) Patent Application Publication
(10) Pub. No.: US 2010/0032559 A1
(43) Pub. Date: Feb. 11, 2010

(54) VARIABLE ENERGY PHOTOIONIZATION DEVICE AND METHOD FOR MASS SPECTROMETRY

(75) Inventors: Viorica Lopez-Avila, Sunnyvale, CA (US); Arthur Schleifer, Portola Valley, CA (US); James E. Cooley, San Francisco, CA (US); Randal S. Urdahl, Mountain View, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(73) Assignee: Agilent Technologies, Inc., Santa Clara, CA (US)

(21) Appl. No.: 12/189,348

(22) Filed: Aug. 11, 2008

(51) Int. Cl. H01J 49/40

(52) U.S. Cl. 250/282; 250/287

(57) ABSTRACT

A mass spectrometer using a variable energy photoionization device for ionizing and/or cleaving molecules is disclosed. The device permits ionizing photon wavelengths to be selected from a range of wavelengths allowing the ionizing photon energies to be tuned so as to ionize molecules without excessive fragmentation or to cleave molecules in a controlled manner by breaking only certain molecular bonds. Selection of the wavelengths is afforded by the choice of a plasma-forming gas combined with windowlessly radiating the ionizing photons from a plasma chamber. A method of mass spectrometry featuring selected ionizing photon wavelengths is also disclosed.

### BACKGROUND

Mass spectrometers provide an analytic tool for the identification of molecular compounds by separating ions derived from the compounds according to their mass-to-charge ratio. In its most basic form a mass spectrometer comprises an ionization device, which ionizes molecules of the sample compound to be analyzed, a mass analyzer, which separates the ions based on their mass-to-charge ratio, an ion detector, which counts the number of ions of each mass-to-charge ratio provided by the mass analyzer, and, a data analysis device, which renders the count from the ion detector into usable form, for example, by generating a mass spectrograph characteristic of the sample.

Certain types of mass analyzers, for example, the multipole time-of-flight mass spectrometer (QTOF-MS), operate most effectively when they receive a high concentration of molecular ions from the ionization device. However, not all ionization devices are capable of producing the requisite concentration of molecular ions from the sample compound. For example, ionization devices which bombard the sample with energetic electrons (known as electron impact or EI ionization) to ionize the sample often generate significant fragmentation of the sample molecules. This reduces the concentration of molecular ions available for the mass analyzer, and thus adversely affects the performance of the mass spectrometer. This tendency toward excess fragmentation makes EI ionization inappropriate for analysis of complex molecules, such as biological samples because it may be difficult to determine the mass-to-charge ratio of such molecules from their fragments.

A further disadvantageous aspect of certain ionization devices is related to their inability to exactly determine the energy transferred to the sample molecule for ionization and thereby adapt the mass spectrometer for the analysis of a variety of different molecules. Using EI ionization again as an example, the energy of the bombarding electrons is typically chosen to be 70 eV, any fraction of which may be imparted to the sample molecule during a collision.

In the analysis of large molecules, for example, molecules of 500,000 amu and higher, it is often advantageous to fragment, or cleave the molecules in a controlled manner for analysis. This may be done by performing multiple mass separation steps coupled with intentional cleaving of the molecules. Tandem mass spectrometry, using three multipole mass analyzers in series, provides an example of such a technique. The first multipole mass analyzer acts as a filter and selects molecular ions with a desired mass-to-charge ratio. These molecular ions are passed to the second multipole mass analyzer, which acts as a collision cell wherein the selected ions are forced to collide with an inert gas and fragment. The ion fragments are passed to the third multipole mass analyzer, which performs another mass separation step by sending selected ion fragments to the ion detector to complete the analysis.

### BRIEF DESCRIPTION OF THE DRAWINGS

FIG. 1 is a schematic view of an ionization chamber having a variable energy photoionization device according to the invention;

FIG. 2 is a plan view of substrate 14 with containment structure 16 removed;

FIG. 3 is a plan view of substrate 14 with containment structure 16 in place;

FIG. 4 is a cross sectional view taken at line 4-4 of FIG. 3;

FIGS. 5-10 are schematic illustrations of various mass spectrometer embodiments using the variable energy photoionization device according to the invention;

FIG. 11 is a flow chart which illustrates a method according to an embodiment of the invention;

FIG. 12 is a flow chart which illustrates an alternate method according to an embodiment of the invention; and

FIGS. 13-16 are mass spectrographs which illustrate the ionization of a steroid by various ionization techniques.

### DETAILED DESCRIPTION

Embodiments of the invention provide a mass spectrometer comprising an ionization chamber and a variable energy photoionization device configured to emit ionizing photons in a selectable wavelength range. The ionization device is positioned within the ionization chamber. A first multipole mass analyzer is positioned adjacent to and in fluid communication with the ionization chamber. An ion detector is in fluid communication with the first multipole mass analyzer for receiving ions therefrom.

Embodiments of the invention further encompass a method of mass spectrometry. The method comprises providing a first plasma-forming gas selected to generate, in response to electrical energy, ionizing photons having wavelengths in a selectable first wavelength range; providing electrical energy to convert the first plasma-forming gas to a first plasma, the first plasma emitting first ionizing photons having wavelengths within the selectable first wavelength range; ionizing sample molecules into respective ions using the first ionizing photons; separating the ions in accordance with their mass-to-charge ratios; and detecting the separated ions.

In an example, the electrical energy is microwave energy. Other examples of electrical energy include direct current, pulsed current (spark discharge), dielectric barrier discharge, and radio frequency energy at frequencies other than those associated with microwaves. The electrical energy may be inductively or capacitively coupled to the plasma-forming gas.

The method may additionally include selecting the selectable first wavelength range such that the first ionizing photons ionize the sample molecules without fragmenting them.

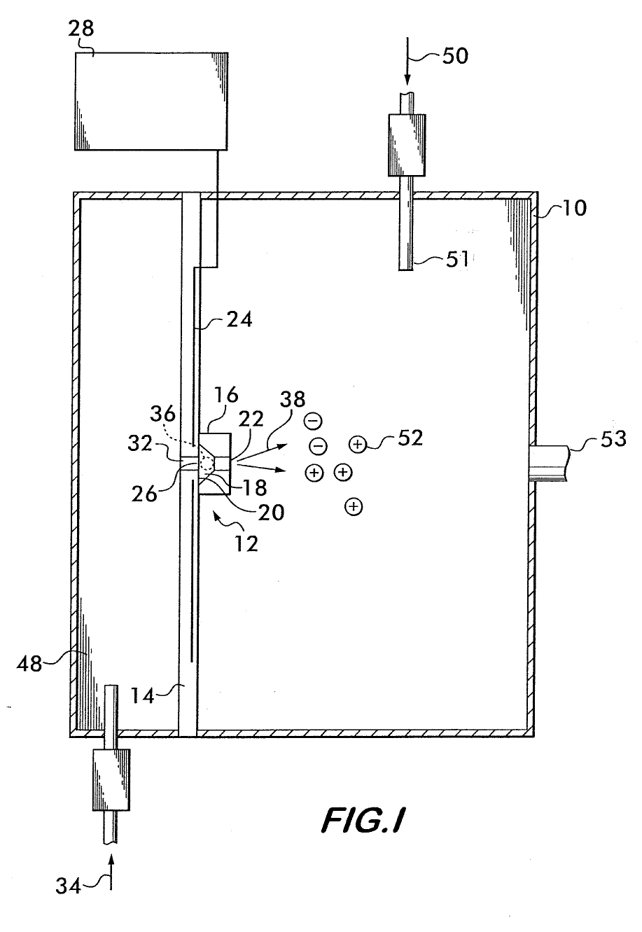

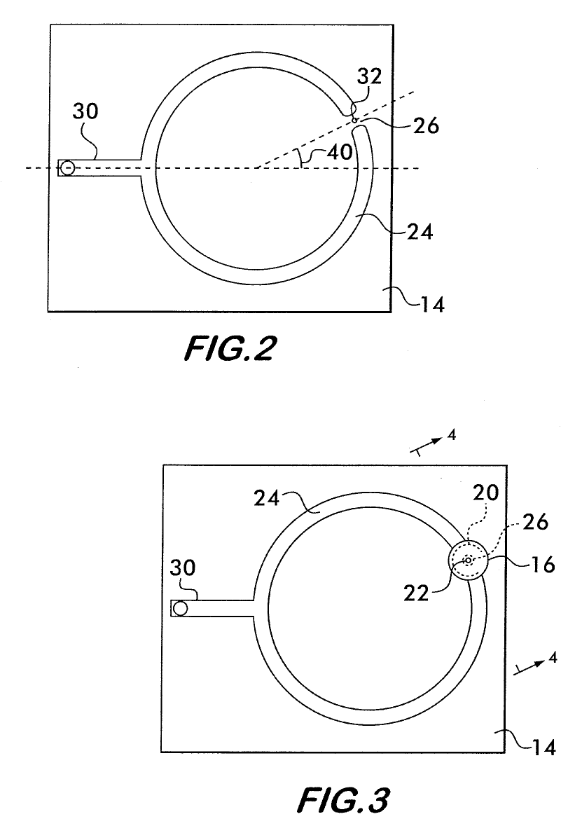

FIG. 1 is a schematic illustration of an ionization chamber 10 in which an example of a variable energy photoionization device 12 is located. Ionization device 12 comprises a substrate 14 on which is mounted a windowless plasma containment structure 16. Plasma containment structure 16 defines a plasma chamber 18 having an inlet aperture 20, and a windowless outlet aperture 22. As shown in FIG. 2, a split-ring resonator 24 is mounted on the substrate 14. Resonator 24 has a discharge gap 26 and is connected to a source of microwave energy, for example, the microwave power supply 28 shown in FIG. 1. Connection to the power supply 28 is made via a quarter wavelength stripline 30, shown in FIG. 2. When microwave energy is supplied to the resonator 24, plasma-forming gas present in the discharge gap 26 is converted to a plasma that emits photons in a wavelength range that depends on the properties of the gas. An inlet vent 32 extends through the substrate 14 and is aligned with the discharge gap 26. The plasma-forming gas flows through the inlet vent 32 into the discharge gap.

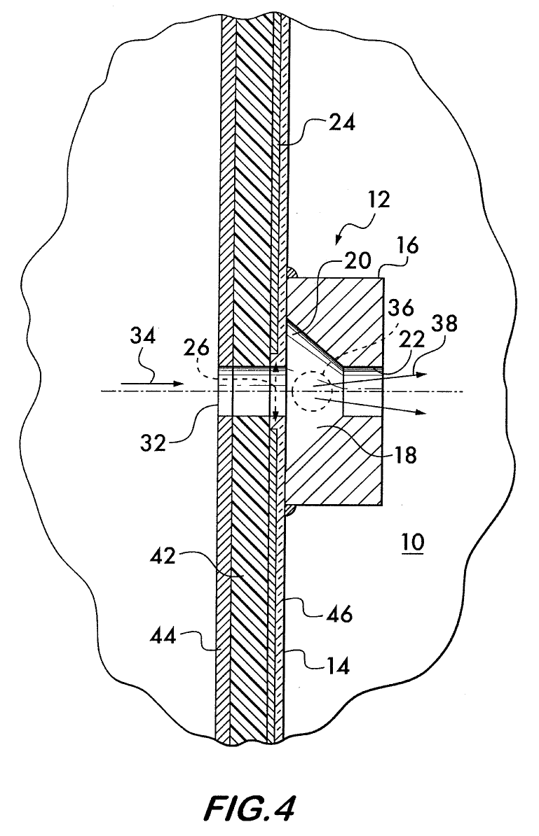

As shown in FIG. 3, the plasma containment structure 16 is mounted on the substrate 14 overlying the discharge gap 26 of the resonator 24. As shown in FIG. 4, the inlet aperture 20 of the containment structure 16 is aligned with the discharge gap 26 and the inlet vent 32 in the substrate 14. Plasma-forming gas 34 enters the discharge gap 26 through the inlet vent 32. Microwave energy supplied to the resonator 24 converts the plasma-forming gas to a photon-emitting plasma 36 in the discharge gap 26. The plasma 36 is then received within the plasma chamber 18 through the inlet aperture 20. Photons 38 generated by the plasma 36 exit the plasma chamber through the windowless outlet aperture 22 into the ionization chamber 10. Because the wavelength of the photons 38 (and thus their energy) depends on the properties of the plasma-forming gas, it is possible to vary the energy of the photons emitted by selecting a particular gas or combination of gases as the plasma-forming gas.

Numerous advantages are realized by the use of the variable energy photoionization device 12. The photon-emitting plasma generated in the discharge gap is a “microplasma”, i.e., a plasma which occupies a volume on the order of 1 cubic millimeter. The microplasma has a high volumetric optical power density allowing for efficient geometric coupling between the ionizing photons and sample molecules in the ionization chamber 10. The efficiency is achieved because the volume from which the ion optics in a mass spectrometer can collect and analyze ions is typically small (on the order of a few cubic mm to 1 cubic cm), and this effectively limits the size of the available ionization region. In addition, photons in the wavelength range of interest are difficult to direct and focus using conventional optics. Efficient coupling may be further achieved by matching the outlet aperture 22 of the photoionization device 12 with the diameter of the inlet admitting the sample to the ionization chamber 10.

The photoionization device 12 operates at low power (less than 100 W). It also operates at low plasma-forming gas flow rates, thereby enabling windowless operation within high-vacuum environments as are typically associated with mass spectrometry. The absence of a window eliminates a source of performance degradation, as a window tends to become contaminated and obscured over time, causing photon output to drop. The windowless structure further allows ionizing photons to be emitted at wavelengths that would be strongly attenuated by various window materials. Therefore, the range of photon wavelengths output by photoionization device 12 is determined exclusively by the composition of the plasma-forming gas.

The wavelengths of the ionizing photons are selectable, based upon the selection of the plasma-forming gas. Judicious selection of the plasma-forming gas allows the energy of the photons to be selected so that the photons have sufficient energy to ionize molecules of interest without fragmenting them. It is also possible to select the energy of the photons so that the photons cleave large molecules in a controlled manner and avoid excessive fragmentation when fragmentation is desired, as in tandem mass spectrometry, for example. The ability to produce ions with little or no fragmentation provides a higher concentration of molecular ions from a given sample, thereby ensuring improved performance of certain mass spectrometer components, such as the above-mentioned QTOF-MS. This permits the determination of the mass-to-charge ratio of the entire molecule, thereby avoiding trying to infer this from the mass-to-charge ratios of several fragments.

The noble gases, helium, neon, krypton, argon and xenon are suitable for use as constituents of the plasma-forming gas in the variable energy photoionization device 12 because they can produce intense resonance radiation when excited by collisions with electrons that have been accelerated by the electric field within the discharge gap 26. The choice of noble gas, or a combination of noble gases, provides ionizing photons having wavelengths in a selectable wavelength range. For example, helium has an optical resonance at 58.43 nm and emits photons having energies of 21.22 eV. Krypton has optical resonances at 116.49 nm and 123.58 nm and emits photons with respective energies of 10.64 eV and 10.03 eV. The argon resonance lines are at 104.82 nm (11.83 eV) and 106.67 nm (11.62. eV) whereas xenon exhibits strong resonance emission at 129.56 nm (9.57 eV) and 146.96 nm (8.44 eV). The windowless structure of photoionization device 12 permits full wavelength selectability within this wavelength range. Additionally noteworthy is the capability of the windowless photoionization source 12 to generate photons in the vacuum ultraviolet range below 120 nm with helium as the plasma-forming gas. In addition to the noble gases, a mixed hydrogen/helium plasma, which emits photons at 121.57 nm, is also a candidate for the plasma-forming gas.

In a specific example embodiment of a variable energy photoionization device 12 according to the invention, the split-ring resonator 24, shown in FIG. 2, has a diameter of 7 mm and operates at a frequency of 2.4 GHz, and discharge gap 26 has a width of about 1 mm. The discharge gap 26 is offset from the quarter wavelength stripline 30 by an offset angle 40 in a range between about 10° to about 14°. These parameters of diameter and offset angle may be optimized for other microwave energy frequencies. As shown in FIG. 4, the resonator 24 is mounted on one side of a dielectric core 42 of the substrate 14. An electrically-conducting backplane 44 is mounted on the opposite side of core 42. The backplane cooperates with the resonator 24 and the dielectric core 42 to create a waveguide through which microwaves propagate. An insulating layer 46 is positioned over the resonator. In an example, the core 42 is a dielectric ceramic and the insulating layer 46 is glass.

The plasma containment structure 16 is mounted on the insulating layer 46. In an exemplary embodiment, the containment structure 16 is formed of a sapphire jewel and has a height of 0.6 mm. The inlet aperture 20 has a diameter of 1 mm and the outlet aperture 22 has a diameter of about 0.2 mm and a length of about 0.2 mm. The inlet vent 32 has a diameter of 0.3 mm. The size of the outlet aperture 22 and the pressure within the plasma chamber 18 control the rate at which the plasma flows from the chamber 18. The size of the outlet aperture is chosen to inhibit gas flow while allowing ionizing photons to exit from the plasma chamber into the ionization chamber. This allows the variable energy photoionization device 12 to operate within the ionization chamber 10 at pressures within the ionization chamber significantly less than 1 Torr. For example, for a pressure in the ionization chamber of about 1 Torr, the pressure within the plasma chamber 18 near the outlet aperture 22 is about 1 Torr and the pressure of the plasma-forming gas 34 upstream of the inlet vent 32 is about 70 Torr. The flow rate of the plasma-forming gas is in the range from about 2 ml/min to about 4 ml/min. The variable energy photoionization device 12 may also be operated within ionization chambers operating at higher pressures. For example, the ionization chamber may be at about atmospheric pressure (760 Torr). In this case, the pressure within plasma chamber 18 is from about 780 Torr to about 810 Torr, and pressure of the plasma-forming gas is about 830 Torr.

Operation of the variable energy photoionization device 12 to ionize molecules without fragmenting them will now be described with reference to FIG. 1. A plasma-forming gas 34 is selected which, in response to microwave energy, will generate ionizing photons having wavelengths (and therefore energies) which will ionize the particular molecules of interest without fragmenting them. The gas 34 is supplied under pressure to a plasma-forming gas plenum 48 adjacent to the substrate 14. The gas 34 passes through the inlet vent 32 to the discharge gap 26. Microwave energy is provided to the split-ring resonator 24 from the power supply 28 and the photon-emitting plasma 36 is formed within the gap and maintained within the plasma chamber 18. Ionizing photons 38 having the selected wavelength or wavelengths are generated by the plasma and exit the plasma chamber 18 through the outlet aperture 22 into the ionization chamber 10. Sample molecules 50 to be ionized without fragmenting them are supplied to the ionization chamber through an ionization chamber inlet 51 where the ionizing photons 38 ionize them. The ions 52 thus formed exit the ionization chamber through an ionization chamber outlet 53 and are available for mass spectrometry analysis.

Operation of the variable energy photoionization device 12 to fragment or cleave molecules will now be described with reference to FIG. 1. A plasma-forming gas 34 is selected which, in response to microwave energy, will generate ionizing photons having wavelengths (and therefore energies) which will cleave molecules of interest in a controlled manner by breaking only certain molecular bonds. The gas 34 is supplied under pressure to a plasma-forming gas plenum 48 adjacent to the substrate 14. The gas 34 passes through the inlet vent 32 to the discharge gap 26. Microwave energy is provided to the split-ring resonator 24 from the power supply 28 and the photon-emitting plasma 36 is formed within the gap and maintained within the plasma chamber 18. Photons 38 having the selected wavelength or wavelengths are generated by the plasma and exit the plasma chamber 18 through the outlet aperture 22 into the ionization chamber 10. Sample molecules 50 to be cleaved are supplied to the ionization chamber through an ionization chamber inlet 51 where the photons 38 cleave them as desired. The ion fragments thus formed exit the ionization chamber through an ionization chamber outlet 53 and are available for mass spectrometry analysis.

FIGS. 5-10 show various embodiments of mass spectrometers which use the variable energy photoionization device 12 according to an embodiment of the invention. FIG. 5 illustrates a mass spectrometer 54 comprising the ionization chamber 10 (hereafter IC 10) as described above, in fluid communication with a multipole mass analyzer 56 (hereafter Q 56). Q 56 is in fluid communication with a detector 58 (hereafter D 58). D 58 may be one of any known detectors used in mass spectrometry, such as a micro-channel plate detector, a Faraday cup, an ion to photon detector, a photomultiplier, an electron multiplier as well as other detector devices. Mass spectrometer 54 is typically used for basic chemical analysis to identify classes of compounds by their ionization potential.

In some applications, IC 10 receives sample molecules 50 from a first separation device, such as a gas chromatograph 60. In other examples, the samples are supplied directly to IC 10, for example, by atmospheric sampling or direct injection. IC 10 ionizes the sample 50 producing ions 52. Q 56 receives the ions 52 from IC 10 and acts as a mass filter, passing only the ions 52′ having a particular mass-to-charge ratio to D 58. IC 10 is positioned in a region 62 of the mass spectrometer 54 which, in some applications, is operated at reduced pressure or vacuum, whereas the other components (Q 56, D 58) are in a region 64 which is operated at vacuum.

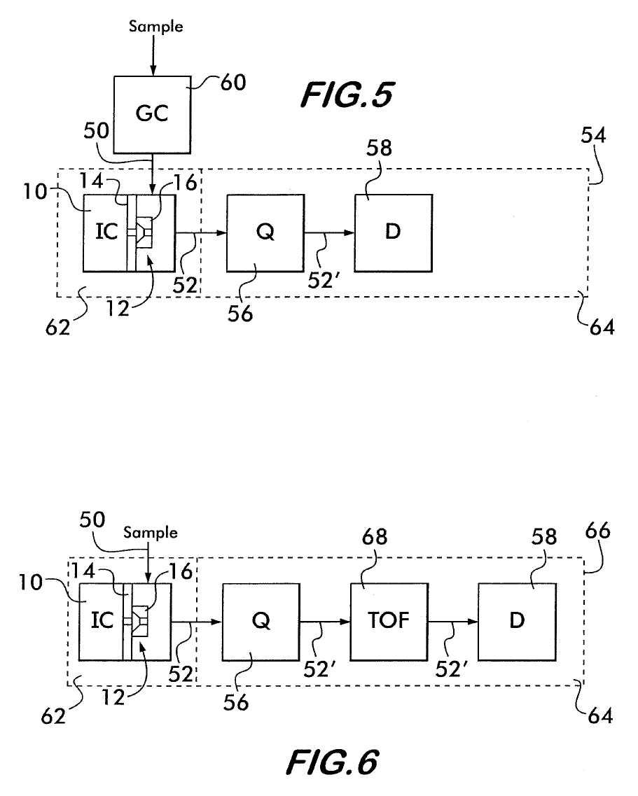

FIG. 6 shows another embodiment of a mass spectrometer 66 which uses IC 10, again in fluid communication with Q 56. A time-of-flight analyzer 68 (hereafter TOF 68) is positioned between Q 56 and D 58, and is in fluid communication with both components. Sample molecules 50 are provided to IC 10, either directly as shown, or through a first separation device, and are ionized to form ions 52. The ions pass to Q 56, which acts as an ion guide when mass spectrometer 66 is operated in single stage mode, or acts as a mass selection device when the mass spectrometer is operated in a multi-stage mode, such as in tandem mass spectrometry. TOF 68 serves as a mass analyzer in both single and multi-stage operation of the mass spectrometer. Mass spectrometer 66 is typically used for qualitative analysis of unknown compounds when high resolution and accuracy are required.

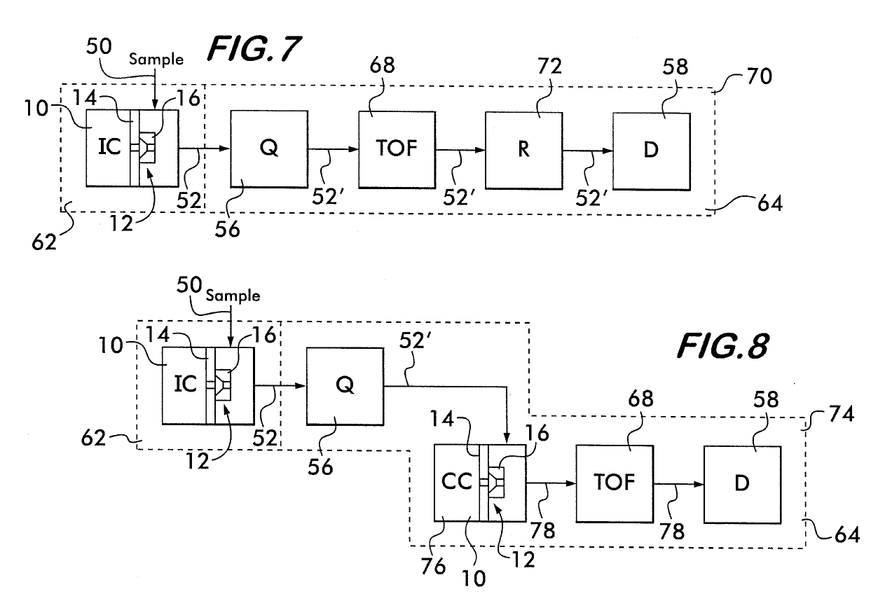

Another mass spectrometer embodiment 70 is shown in FIG. 7. This embodiment is similar to mass spectrometer 66, but incorporates a reflectron 72 which works in conjunction with TOF 68 to direct ions to D 58. Like mass spectrometer 66, mass spectrometer 70 typically provides qualitative analysis of unknown compounds with a high degree of confidence.

Mass spectrometer embodiment 74, shown in FIG. 8, comprises a cleaving cell 76 positioned between and in fluid communication with Q 56 and TOF 68. Cleaving cell 76 comprises a second ionization chamber 10 within which is mounted a second variable energy photoionization device 12. The cleaving cell 76 is used instead of a collision cell to cleave ions 52′ supplied by Q 56 when mass spectrometer 74 is operated in the multi-stage mode. The advantages of the variable energy photoionization device 12 are readily realized in this embodiment at the first ionization stage, where the sample molecules 50 are ionized without excessive fragmentation due to the ability to select the wavelengths (and, hence, the energies) of the ionizing photons. The advantages are realized as well in the cleaving cell 76, where the photon energies are selected to cleave the ions 52′ (which comprise the subset of molecular ions 52 selected by Q 56) in a controlled manner, for example, by generating photons having energies which will cleave only certain molecular bonds of interest to the exclusion of other molecular bonds. The cleaved ions 78 are sent to TOF 68 which acts as a mass analyzer, and then on to D 58 for detection. Mass spectrometer 74 is typically used for qualitative analysis in the identification of complex proteins.

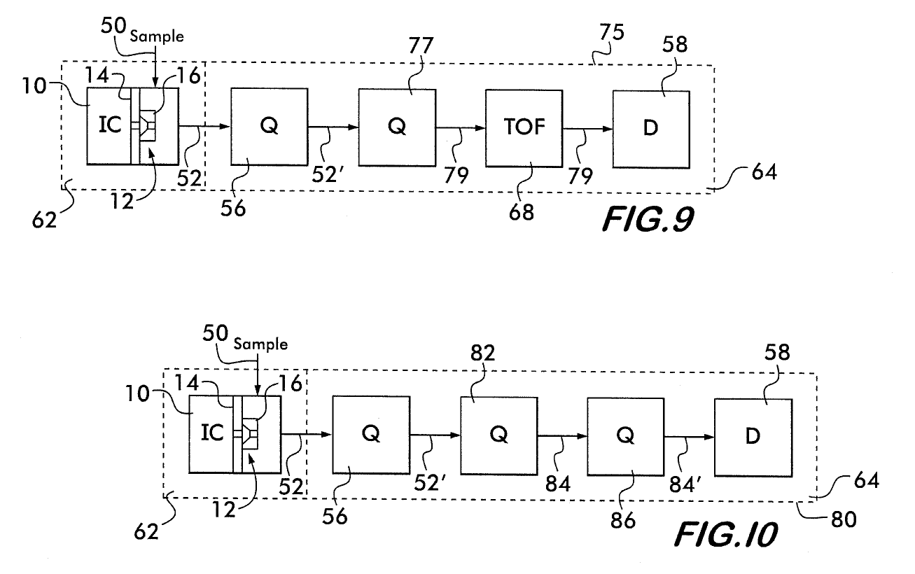

Mass spectrometer embodiment 75 is shown in FIG. 9 and comprises a collision cell 77 positioned between and in fluid communication with Q 56 and TOF 68. In this example collision cell 77 comprises a multipole mass analyzer—operated as a collision cell by allowing the ions 52′ selected by Q 56 to collide with an inert gas within the multipole mass analyzer. Ion fragments 79 generated by the collision cell 77 are sent to TOF 68, which acts as a mass analyzer, and then on to D 58 for detection. Mass spectrometer 75 is used of qualitative analysis of complex proteins similarly to mass spectrometer 74.

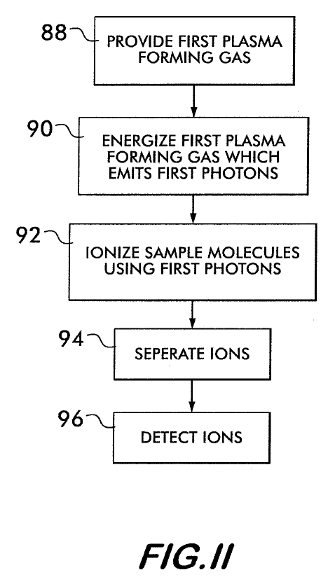

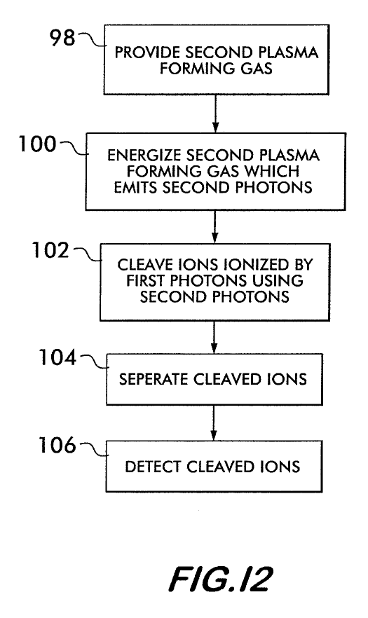

Mass spectrometer embodiment 80 is shown in FIG. 10 and comprises IC 10, which ionizes the sample molecules 50 and sends the ions 52 to Q 56, which acts as a mass filter and passes a selected subset of the ions 52′ as noted above for other embodiments. Ions 52′ from Q 56 are sent to a second multipole mass analyzer 82 (hereafter Q 82) which acts as a collision cell by allowing the ions 52′ to collide with an inert gas such as helium or argon. This induces fragmentation of the ions and produces ion fragments 84 which are received by a third multipole mass analyzer 86 (hereafter Q 86). Q 86 acts as another mass analyzer and sends a subset 84′ of the fragments 84 to D 58 for detection. Mass spectrometer 80 is typically used for quantitative analysis of known compounds, for example, to determine how much of a known compound in present in a sample.

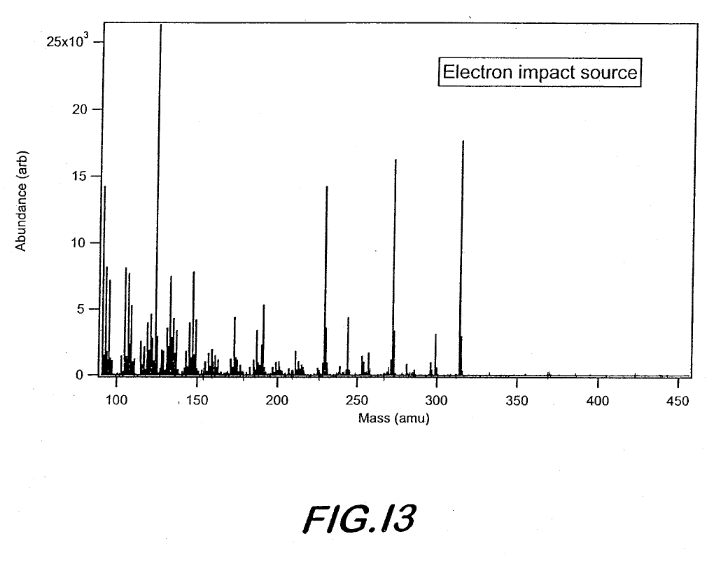

A method of mass spectrometry according to the invention is illustrated in FIG. 11. The method comprises providing a first plasma-forming gas 88. The plasma-forming gas provided is selected to generate, in response to electrical energy, for example, microwave energy, ionizing photons at a wavelength or wavelengths (and thereby at an energy or energies) in a selectable first wavelength range. The first plasma-forming gas may be a single gas or combination of gases, and is selected such that the ionizing photons will ionize sample molecules such that molecular ion signal is maximized. Helium, neon, krypton, argon, xenon and hydrogen and combinations thereof comprise an incomplete list of candidate gases for the plasma-forming gas.

Microwave energy is provided to the plasma-forming gas at 90. The microwave energy converts the plasma-forming gas to a plasma that emits first ionizing photons having wavelengths within the selectable wavelength range. At 92, the first ionizing photons are used to ionize the sample molecules into respective ions. At 94, the ions formed from the sample molecules are separated, for example in accordance with their mass-to-charge ratio, and the separated ions are detected at 96.

Additionally, before detection at 96, a second plasma-forming gas may be provided as shown at 98 in FIG. 12. The second plasma-forming gas is selected to generate, in response to electrical energy, for example, microwave energy, photons at a wavelength or wavelengths (and thereby at an energy or energies) in a second selectable wavelength range. The second wavelength range is selected to cleave the ions separated at 94. The second plasma-forming gas may be a single gas or combination of gases, and is selected so that photons having wavelengths in the second wavelength range will cleave the ions in a controlled manner, for example, breaking only certain molecular bonds of interest. At 100, microwave energy is provided to convert the second plasma-forming gas to a second plasma that emits second photons in the second wavelength range. The second photons are used to cleave the ions ionized by the first photons as shown at 102. The cleaved ions are separated at 104 and then detected at 106.

Mass spectrometers using the variable energy photoionization device obtain distinct advantages due to the ability of the photoionization device to provide photons having wavelengths in a selectable wavelength range and thereby to select the photon energy used to ionize or cleave molecules in a controlled manner.

### Example

The example described below illustrates the effectiveness of the variable energy photoionization device according to the invention for producing ionized molecules with reduced or no fragmentation, i.e. molecular ions. In the example, a known steroid, progesterone, with a molecular weight of 314 amu, is subject to four different ionization conditions. The first ionization condition is provided by an electron impact ionization source. The remaining three ionization conditions are provided by a photoionization source according to an embodiment of the invention using three different plasma-forming gases, each of which produces photons having different energies. The identification of steroids is expected to benefit by use of the photoionization device according to embodiments of the invention because steroids in general undergo extensive fragmentation when subject to high electron impact energies (e.g. 70 eV). Such fragmentation can make unique identification of compounds with similar masses difficult. Thus, a soft ionization source, i.e., a device which can produce a large abundance of molecular ions without fragmentation, can provide an accurate measurement of molecular weight and therefore help differentiate between molecules of similar mass. The Example illustrates the advantage provided by an ionization device which offers a variety of energies optimized for the ionization of different molecules with reduced or no fragmentation.

FIG. 13 shows a spectrograph obtained after progesterone was ionized by electron impact (EI) with electrons at 70 eV using an unmodified gas chromatograph mass spectrometer, Agilent Model 5973. This apparatus comprises an electron impact ionization source, a single multipole mass analyzer and an electron multiplier detector. The apparatus was operated under the control of a computer running Agilent “Chemstation” software.

The spectrograph shown in FIG. 13 plots ion abundance against mass-to-charge ratio, and shows the highest mass-to-charge ratio of 314, close to the known molecular weight of progesterone. The many peaks of lower molecular weight indicate significant fragmentation, as expected when a molecule having an ionization energy of about 10 eV is bombarded with electrons having seven times the required ionization energy. If this were a spectrograph of an unknown sample, one could not reliably conclude that the highest mass-to-charge peak represented the molecular ion, as the peak could be due to a molecular fragment.

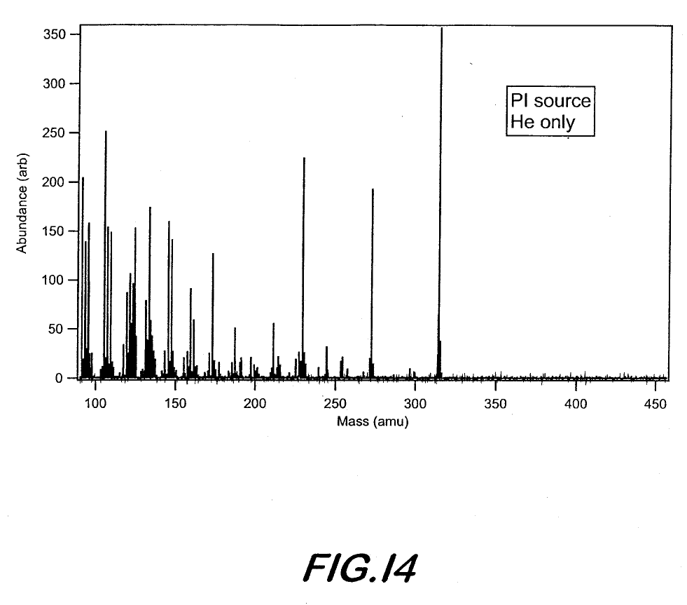

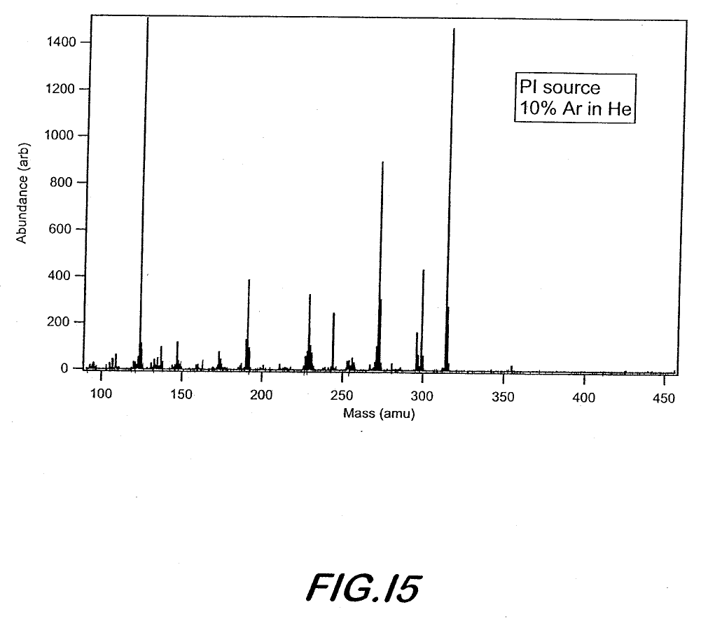

FIG. 14 shows a spectrograph obtained after progesterone was ionized by photons emitted from a windowless variable energy photoionization device according to an embodiment of the invention. The variable energy photoionization device was substituted for the electron impact ionization source in the Agilent Model 5973 mass spectrometer described above. Only helium was used as the plasma-forming gas. The resonance line of helium at about 58.4 nm yields photons with energies of about 21.2 eV, significantly lower than the EI energies but higher than the ionization energy of progesterone. The spectrograph in FIG. 14 still shows molecular fragmentation, as evidenced by the numerous peaks below the mass-to-charge ratio (m/z) of 314, but significantly fewer than in the spectrograph displayed in FIG. 13.

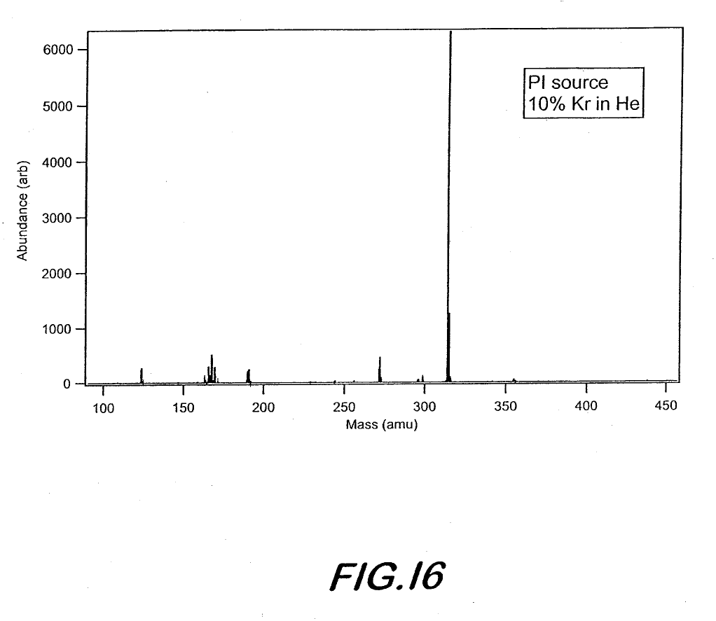

FIG. 15 shows a spectrograph produced by the above-mentioned modified Agilent Mass Spectrometer, in which progesterone was ionized by photons emitted from the windowless variable energy photoionization device using 10% argon in helium as the plasma-forming gas. The resonance emission of an argon/helium plasma yields photons with energies of about 11.6 eV and 11.8 eV, significantly lower than the energy provided by an EI source or pure helium plasma, but again, higher than the ionization energy of progesterone. The spectrograph in FIG. 15 exhibits significantly less molecular fragmentation than either of spectrographs displaced in FIGS. 13 and 14, as evidenced by fewer peaks below m/z=314.

FIG. 16 shows a spectrograph, again produced by the modified Agilent mass spectrometer in which progesterone was ionized by photons emitted from a windowless variable energy photoionization device according to an embodiment of the invention using 10% krypton in helium as the plasma-forming gas. The resonance lines of the krypton/helium plasma are at energies of about 10.0 and 10.6 eV, slightly higher than the ionization energy of progesterone. The spectrograph in FIG. 16 shows little molecular fragmentation, as evidenced by the small number of peaks below m/z=314. Comparison of the four spectrographs displayed in FIGS. 13-16 also allows one to conclude with some confidence that the highest observed mass-to-charge ratio of 314 represents the mass-to-charge ratio of the molecular ion. The spectrographs also demonstrate the ability of the photoionization device to generate photons that discriminate, depending on the mass resolution of the instrument, between molecules close in molecular weight, thereby facilitating the identification of compounds, such as steroids, which may differ only slightly in composition.

What is claimed is:

1. A mass spectrometer, comprising:
an ionization chamber;
a windowless variable energy photoionization device configured to generate ionizing photons in a selectable wavelength range, said ionization device being positioned within said ionization chamber;
a first multipole mass analyzer positioned adjacent to and in fluid communication with said ionization chamber; and
an ion detector in fluid communication with said first multipole mass analyzer for receiving ions therefrom.

2. The mass spectrometer according to claim 1, wherein said windowless variable energy photoionization device comprises:
a split-ring resonator defining a discharge gap;
a windowless plasma containment structure defining a plasma chamber having an inlet aperture and an outlet aperture, said inlet aperture facing said discharge gap; and
an inlet vent extending into said discharge gap.

3. The mass spectrometer according to claim 2, wherein said inlet vent is operable to conduct plasma-forming gas having a predetermined composition into said containment structure such that microwave energy supplied to said split-ring resonator converts said plasma-forming gas to a photon-emitting plasma within said plasma chamber, said photon-emitting plasma emitting said ionizing photons into said ionization chamber, said ionizing photons having wavelengths within said selectable wavelength range, said wavelengths being dependent upon the composition of said plasma-forming gas.

4. The mass spectrometer according to claim 3, wherein, in response to said microwave energy, said plasma-forming gas generates photons at a wavelength selected to ionize a sample molecule without fragmenting it.

5. The mass spectrometer according to claim 1, further comprising a first separation device in fluid communication with said ionization chamber for providing sample molecules thereto for ionization.

6. The mass spectrometer according to claim 5, wherein said first separation device comprises a gas chromatograph.

7. The mass spectrometer according to claim 1, further comprising a time-of-flight analyzer positioned between said first multipole mass analyzer and said ion detector and in fluid communication therewith, said time-of-flight analyzer conducting ions from said first multipole mass analyzer to said ion detector.

8. The mass spectrometer according to claim 7, further comprising a reflectron positioned between said time-of-flight analyzer and said detector and in fluid communication therewith, said reflectron conducting ions from said time-of-flight analyzer to said ion detector.

9. The mass spectrometer according to claim 7, further comprising a collision cell positioned between and in fluid communication with said first multipole mass analyzer and said time-of-flight analyzer.

10. The mass spectrometer according to claim 9, wherein said collision cell comprises a second multipole mass analyzer.

11. The mass spectrometer according to claim 7, further comprising a cleaving cell positioned between and in fluid communication with said first multipole mass analyzer and said time-of-flight analyzer, said cleaving cell comprising a second variable energy photoionization device positioned within a second ionization chamber, said second variable energy photoionization device configured to emit second ionizing photons in a selectable second wavelength range.

12. The mass spectrometer according to claim 11, wherein said second variable energy photoionization device comprises:
a second split-ring resonator defining a second discharge gap;
a second windowless plasma containment structure defining a second plasma chamber having a second inlet aperture and a second outlet aperture, said second inlet aperture facing said second discharge gap; and
a second inlet vent extending into said discharge gap.

13. The mass spectrometer according to claim 12, wherein said second inlet vent is operable to conduct a second plasma-forming gas having a predetermined composition into said second plasma containment structure such that microwave energy supplied to said second split-ring resonator converts said second plasma-forming gas to a second photon-emitting plasma within said second plasma chamber, said second photon-emitting plasma emitting said second ionizing photons into said second ionization chamber, said second ionizing photons having wavelengths within said selectable second wavelength range, said wavelengths of said second ionizing photons being dependent upon the composition of said second plasma-forming gas.

14. The mass spectrometer according to claim 13, wherein said second ionizing photons emitted from said second photon-emitting plasma are selected to cleave ions supplied thereto from said first multipole mass analyzer, cleaved ions from said second ionization chamber being received within said time-of-flight analyzer.

15. The mass spectrometer according to claim 1, further comprising a collision cell positioned between and in fluid communication with said first multipole mass analyzer and said ion detector.

16. The mass spectrometer according to claim 15, wherein said collision cell comprises a second multipole mass analyzer.

17. The mass spectrometer according to claim 16, further comprising a third multipole mass analyzer positioned between and in fluid communication with said second multipole mass analyzer and said ion detector.

18. A method of mass spectrometry, comprising:
providing a first plasma-forming gas selected to generate, in response to electrical energy, ionizing photons having wavelengths in a selectable first wavelength range;
providing electrical energy to convert said first plasma-forming gas to a first plasma, said first plasma emitting first ionizing photons having wavelengths within said selectable first wavelength range;
ionizing sample molecules into respective ions using said first ionizing photons, said ions having respective mass-to-charge ratios;
separating said ions in accordance with the mass-to-charge ratios thereof; and
detecting said ions after said separating.

19. The method according to claim 18, further comprising selecting said first wavelength range such that said first ionizing photons ionize said sample molecules without fragmenting them.

20. The method according to claim 19, wherein said first plasma-forming gas is selected from the group consisting of helium, neon, argon, krypton, xenon, hydrogen, and combinations thereof.

21. The method of mass spectrometry according to claim 18, further comprising:
providing a second plasma-forming gas selected to generate, in response to electrical energy, ionizing photons having wavelengths in a selectable second wavelength range;
providing electrical energy to convert said second plasma-forming gas to a second plasma, said second plasma emitting second ionizing photons having wavelengths within said selectable second wavelength range; and
exposing said sample molecules ionized by said first ionizing photons to said second ionizing photons.

22. The method according to claim 21, further comprising selecting said second wavelength range such that said second ionizing photons cleave said sample molecules ionized by said first ionizing photons.

23. The method according to claim 18, wherein said electrical energy comprises microwave energy.
